(19) United States
(12) Patent Application Publication
(10) Pub. No.: US 2025/0023184 A1
(43) Pub. Date: Jan. 16, 2025

(54) BATTERY MODULE ASSEMBLY, BATTERY MODULE COMPRISING SUCH AN ASSEMBLY, AND METHOD OF MANUFACTURING AN ASSEMBLY

(71) Applicant: Robert Bosch GmbH, Stuttgart (DE)

(72) Inventors: Frank Gottwald, Weissach (DE); Markus Schmitt, Tamm (DE); Ralph Glemser, Brackenheim (DE); Sinasi Temiz, Ebersbach (DE)

(21) Appl. No.: 18/758,057

(22) Filed: Jun. 28, 2024

(30) Foreign Application Priority Data
Jul. 10, 2023 (DE) 10 2023 206 523.1

(51) Int. Cl. H01M 50/296; H01M 50/262; H01M 50/505; H01M 50/588

(52) U.S. Cl. CPC H01M 50/296; H01M 50/262; H01M 50/505; H01M 50/588

(57) ABSTRACT

An assembly of a battery module with a housing includes a connection assembly. The connection assembly includes a contact element, configured for electrical contacting of an outside of the battery module, and a busbar, configured for electrical contacting with at least one battery cell accommodated in an interior of the battery module. The contact element and the busbar are connected to one another in a mechanically and electrically conductive manner. The busbar is connected to the housing in such a way that rotation about a longitudinal axis of the busbar is prevented.

### BACKGROUND

The invention is based on an assembly of a battery module according to the disclosure. The present invention also relates to a battery module with such an assembly and a method for manufacturing such an assembly.

It is known from the prior art that a battery module has a plurality of individual battery cells, each of which has a positive voltage tap and a negative voltage tap, wherein the respective voltage taps are electrically conductively connected to one another for an electrically conductive serial and/or parallel connection of the plurality of battery cells to one another and can thus be interconnected to form the battery module. In particular, the battery cells can each have a first voltage tap, in particular a positive voltage tap, and a second voltage tap, in particular a negative voltage tap, which are electrically conductively connected to each other by means of cell connectors, so that an electrically serial and/or parallel connection is formed. Battery modules are themselves in turn interconnected into batteries or entire battery systems.

Usually, the plurality of battery cells of the battery module are housed in a housing of the battery module. The electrical connections from an interior of the battery module must be fed through the housing to enable electrical contacting of the plurality of battery cells. This is usually done with assemblies that comprise contact elements.

### SUMMARY

An assembly of a battery module with the features of the disclosure offers the advantage that a reliable manufacture of a battery module can be formed.

In accordance with the invention, a battery module assembly is provided for this purpose. Such an assembly comprises a housing in which a connection assembly is accommodated. The connection assembly comprises a contact element and a busbar. In particular, the contact element can be designed as a screw-on element, such as a screw-on bolt. The contact element is designed for electrical contacting from the outside of the battery module. The busbar is designed for electrical contacting with at least one battery cell housed in the interior of the battery module. Furthermore, the contact element and the busbar are mechanically and also electrically connected to each other.

According to the invention, the busbar is connected to the housing, in particular with a form-fit manner, in such a way that rotation about a longitudinal axis of the busbar is prevented.

At this point, it should be noted that the connection assembly is used for electrical contacting, in particular of a plurality of battery cells accommodated in the interior of a housing of a battery module through the housing of the battery module and can thus form an electrical connection.

It is useful if the busbar has at least one recess in which a projection of the housing engages in a form-fit manner and/or if the busbar has at least one projection which engages in a form-fit manner in a recess of the housing. This offers the advantage that a reliable connection can be formed between the busbar and the housing. In particular, a reliable form-fit connection can be formed.

It is also useful if the at least one recess and/or the at least one projection are arranged on an outer circumference of the busbar. At this point, it should be noted that the connection assembly has a longitudinal direction that is essentially parallel to the longitudinal direction of the contact element and the longitudinal direction of the busbar. The outer circumference of the busbar defines a surface which is arranged perpendicular to the longitudinal direction of the connection assembly, the longitudinal direction of the contact element, and the longitudinal direction of the busbar. Such an arrangement of the at least one recess and/or the at least one projection on an outer circumference of the busbar can prevent the busbar from rotating about the longitudinal direction or the longitudinal axis relative to the housing when the contact element is contacted. This can prevent any forces that may occur during such contacting from acting on the connection between the busbar and a battery cell housed in the interior of the housing of the battery module, which would mechanically stress such a connection.

In other words, this means that when a connector is mounted from the outside of the battery module on the contact element, which is designed in particular as a screw-on element, such as a screw-on bolt, torques occurring during a screwing process can be absorbed by the connection of the busbar to the housing and do not act on a connection of the busbar to a battery cell.

It is advantageous if the busbar has a first section and a second section. The first section is designed for electrical contacting with at least one battery cell housed in an interior of the battery module. The second section is mechanically and electrically connected to the contact element.

Furthermore, the first section and the second section are arranged at right angles to each other.

At this point, it should also be noted that the aforementioned at least one recess and/or the aforementioned at least one projection are arranged on an outer circumference of the second section. Furthermore, the longitudinal direction or the longitudinal axis of the busbar should correspond to the longitudinal direction of the first section.

It is particularly preferred that the contact element and the busbar are connected to each other in a form-fit and/or material-fit manner. This enables reliable transmission of an electrical current from the contact element to the busbar or from the busbar to the contact element.

According to a preferred aspect of the invention, the contact element is furthermore accommodated in a sleeve in a force-fit and/or form-fit manner. In particular, this connection is designed in such a way that a fluid-tight connection is formed between the contact element and the sleeve. In particular, the contact element, such as the screw-on bolt, is pressed into the sleeve. Furthermore, the sleeve is connected to the housing in a form-fit and/or force-fit manner.

It should be noted at this point that relative movements between the contact element and the sleeve during assembly and/or operation are prevented by the force-fit or frictional connection.

In addition, this receptacle for the contact element in the sleeve can be designed in such a way that reliable sealing against a liquid is ensured, even without mounting a plug or connecting a plug to the contact element. In particular, the press fit of the contact element in the sleeve serves as such a seal.

Furthermore, the connection of the sleeve to the housing offers the advantage that a contact surface for the contact element is formed on the housing by means of the sleeve.

According to a further preferred aspect of the invention, a sealing element is furthermore arranged circumferentially on an outer side of the sleeve. In particular, the sealing element is designed as a shrink tube. This allows a reliable seal to be formed between the housing of the assembly and the connection assembly.

It should be noted at this point that the shrink tube can be arranged both before and after the contact element in the sleeve.

The shrink tube is preferably made of a thermoplastic elastomer. This offers the particular advantage that, by thermally activating this thermoplastic elastomer or thermally activating the shrink-on process, a tight connection can be formed between the sleeve and the shrink tube as well as the shrink tube and the housing of the assembly, even without mounting a plug or connecting a plug to the contact element.

Furthermore, according to a further preferred aspect of the invention, a sealing element is also arranged on an outer side of the housing. In particular, the sealing element is arranged around the outer side of the housing.

Another object of the present invention is a battery module with an assembly according to the invention just described. The assembly is housed in a housing of the battery module.

In addition, the present invention also relates to a method of manufacturing a battery module assembly according to the invention just described. A connection assembly, which comprises a contact element, in particular a screw-on element, designed for electrical contacting from an outside of the battery module, and also a busbar, designed for electrical contacting of at least one battery cell accommodated in an interior of the battery module, which are also mechanically and electrically conductively connected to one another, is overmolded in such a way that the busbar is connected to the housing, in particular in a form-fit manner, in such a way that rotation about a longitudinal axis of the busbar is prevented.

It should be noted at this point that overmolding can be used to form a form-fit connection between the busbar and the housing of the assembly.

In particular, the connection assembly can be inserted into an injection mold for the housing and overmolded using an injection molding process. A sealing element can then also be arranged on the outer side of the housing.

Overall, an embodiment according to the present invention offers the advantage that the connection between the housing of the assembly and the busbar, which is designed in particular to be form-fit, means that both the electrically conductive connection and the sealing point are not subjected to any mechanical preload and are not weakened as a result.

### BRIEF DESCRIPTION OF THE DRAWINGS

Exemplary embodiments of the invention are shown in the drawings and explained in more detail in the following description.

The following is shown in the figures:

FIG. 1 a battery module according to the invention,

FIG. 2 a sectional view of a battery module assembly according to the invention, and

FIG. 3 a connection assembly of a battery module assembly according to the invention in a perspective view.

### DETAILED DESCRIPTION

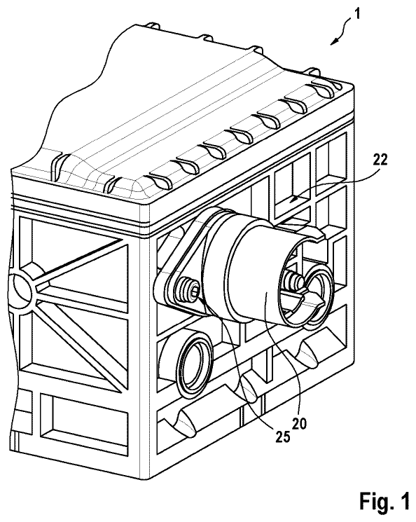

FIG. 1 shows a battery module 1 according to the invention. The battery module 1 comprises a housing 22 with an interior 9, in which a plurality of battery cells 10 of the battery module 1, which cannot be seen in FIG. 1, are accommodated. Furthermore, the battery module 1 comprises an assembly 20, which is accommodated in the housing 22 of the battery module 1.

For example, the assembly 20 is held in the housing 22 of the battery module 1 by means of screw connections 25.

The assembly 20 is used for electrical contacting, in particular of the plurality of battery cells 10 accommodated in the interior 9 of the housing 20 of the battery module 1 through the housing 22 of the battery module 1.

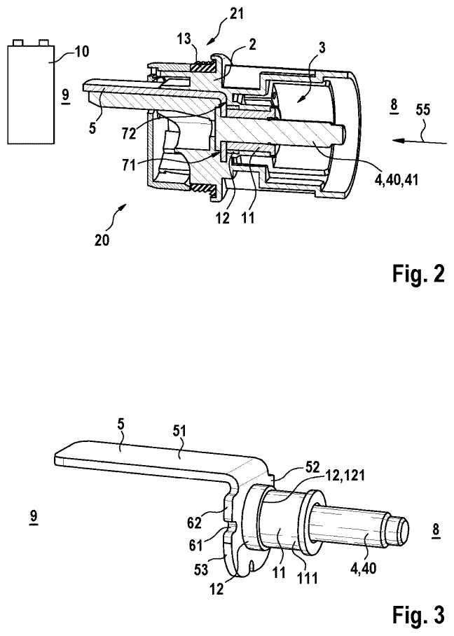

FIG. 2 shows a sectional view of an assembly 20 of a battery module 1 according to the invention.

The assembly 20 comprises a housing 2 in which a connection group 3 is accommodated. The connection assembly 3 has a contact element 4 and a busbar 5. The contact element 4 is designed in particular as a screw-on element 40, such as a screw-on bolt 41.

The contact element 4 is designed for electrical contacting from an outside 8 of the battery module 1.

Furthermore, the busbar 5 is designed for electrical contacting with at least one battery cell 10 accommodated in an interior 9 of the battery module 1.

Furthermore, the contact element 4 and the busbar 5 are mechanically and electrically connected to each other.

The busbar 5 is connected to the housing 2 in such a way, in particular by means of a positive fit, that rotation about a longitudinal axis 55 of the busbar 5 is prevented.

In particular, the busbar 5 comprises at least one recess 61, which can be seen in FIG. 3 and in which a projection 72 of the housing 2 engages in a form-fit manner, and/or the busbar 5 comprises at least one projection 62, which can be seen in FIG. 3 and which engages in a recess 71 of the housing 2 in a form-fit manner.

Furthermore, the contact element 4 is force-fit and/or form-fit, in particular pressed in, in a sleeve 11. The sleeve 11 is connected to the housing 2 in a form-fit and/or force-fit manner.

A sealing element 13 is also arranged on an outer side 21 of the housing 2, wherein the sealing element 13 is arranged in particular circumferentially on the outer side 21 of the housing 2.

FIG. 3 shows a connection assembly 3 of an assembly 20 of a battery module 1 according to the invention in a perspective view.

Firstly, the contact element 4 and the busbar 5 can be seen, which are mechanically and electrically connected to each other.

Furthermore, the at least one recess 61 already mentioned in connection with FIG. 2 and the at least one projection 62 already mentioned in connection with FIG. 2 can be seen, which are also arranged on an outer circumference 53 of the busbar 5.

The busbar 5 has a first section 51 and a second section 52. The first section 51 is designed for electrical contacting with the battery cell 10 accommodated in the interior 9 of the housing 22 of the battery module 1. The second section 52 is mechanically and electrically connected to the contact element 4.

The first section 51 and the second section 52 are arranged at right angles to each other.

In particular, the contact element 4 and the busbar 5 are connected to each other in a form-fit and/or force-fit manner.

Furthermore, the contact element 4 is force-fit and/or form-fit, in particular pressed in, in a sleeve 11. A scaling element 12, in particular a shrink tube 121, is arranged around the outer side 111 of the sleeve 11.

1. An assembly of a battery module (1) having
a housing (2), in which
a connection assembly (3) is accommodated, the connection assembly (3) comprising
a contact element (4), configured for electrical contacting of an outside (8) of the battery module (1), and
a busbar (5) configured for electrical contacting with at least one battery cell (10) accommodated in an interior (9) of the battery module (1), the contact element (4) and the busbar (5) being connected to one another in a mechanically and electrically conductive manner,
wherein the busbar (5) is connected to the housing (2) in such a way that rotation about a longitudinal axis (55) of the busbar (5) is prevented.

2. The assembly according to claim 1, wherein the busbar (5) has at least one recess (61) in which a projection (72) of the housing (2) engages in a form-fit manner, and/or
the busbar (5) has at least one projection (62) which engages in a form-fit manner in a recess (71) of the housing (2).

3. The assembly according to claim 2, wherein the at least one recess (61) and/or the at least one projection (62) are arranged on an outer circumference (53) of the busbar (5).

4. The assembly according to claim 1, wherein the busbar (5) has a first section (51), configured for electrical contacting of at least one battery cell (10) accommodated in an interior (9) of the battery module (1), and a second section (52) arranged at right angles to the first section (51),
wherein the second section (52) is connected to the contact element (4) in a mechanically and electrically conductive manner.

5. The assembly according to claim 1, wherein the contact element (4) is connected to the busbar (5) in a form-fit and/or material-fit manner.

6. The assembly according to claim 1, wherein the contact element (4) is further accommodated in a sleeve (11) in a force-fit and/or form-fit manner, the sleeve (11) being connected to the housing (2) in a form-fit and/or force-fit manner in such a way that a fluid-tight connection is formed between the contact element (4) and the sleeve (11).

7. The assembly according to claim 6, wherein a sealing element (12) is arranged circumferentially on an outer side (111) of the sleeve (11).

8. The assembly according to claim 1, wherein a sealing element (13) is arranged on an outer side (21) of the housing (2).

9. A battery module with an assembly (20) according to claim 1, which is accommodated in a housing (22) of the battery module (1).

10. A method for manufacturing the assembly (20) of claim 1, comprising overmolding the connection assembly (3) in such a way that the busbar (5) is connected to the housing (2) in such a way that rotation about the longitudinal axis (55) of the busbar (5) is prevented.

11. The assembly according to claim 1, wherein the contact element (4) is a screw-on element (40).

12. The assembly according to claim 1, wherein the busbar (5) is connected to the housing (2) in a form-fit manner.

13. The assembly according to claim 6, wherein the contact element (4) is pressed-in the sleeve (11).

14. The assembly according to claim 7, wherein the sealing element (12) is a shrink tube (121).

15. The assembly according to claim 8, wherein the sealing element (13) is arranged in circumferentially on the outer side (21) of the housing (2).
